(19) United States
(12) Patent Application Publication
(10) Pub. No.: US 2026/0177230 A1
(43) Pub. Date: Jun. 25, 2026

(54) POOL LIGHTING APPARATUS

(71) Applicant: Shenzhen Chengsu Technology Co., Ltd., Shenzhen (CN)

(72) Inventor: Shuhan LIU, Shangqiu (CN)

(21) Appl. No.: 19/537,587

(22) Filed: Feb. 12, 2026

(51) Int. Cl. F21V 21/116; B25B 5/06; F21Y 115/10

(52) U.S. Cl. CPC F21V 21/116; B25B 5/068; F21Y 2115/10

(57) ABSTRACT

A pool lighting apparatus, including: a first portion having a first surface; a second portion connected to the first portion and having a second surface, the second surface intersects the first surface, and the second portion comprises a illumination assembly; a clamping assembly connected to the first portion, wherein the clamping assembly and the second surface cooperate to define a clamping space, the clamping space is configured to receive a pool wall therein, wherein the clamping assembly being movable along an adjustment direction to vary a size of the clamping space, the adjustment direction being parallel to the first surface. By adjusting a position of the first clamping plate, the size of the clamping space can be adjusted to accommodate swimming pools with different wall thicknesses.

### TECHNICAL FIELD

The present disclosure relates to the technical field of lighting apparatuses, and in particular to a pool lighting apparatus.

### BACKGROUND

Swimming pool serves as a dedicated venue for swimming activities, water-based recreation, and competitive events, thereby providing users with an important space for leisure, physical exercise, and social interaction. In practical use, due to constraints imposed by busy daytime work or study schedules, nighttime periods frequently constitute peak usage times for swimming pools. Consequently, under nighttime conditions or in circumstances where ambient natural light is insufficient, reliable and effective illumination of the pool area becomes critical infrastructure for ensuring activity safety and enhancing user experience.

At present, in order to achieve the aforementioned function, in addition to dedicated pool lamps submerged underwater, the related art further discloses lighting apparatuses configured to be clamped onto a pool wall. Such lighting apparatuses are secured by clamping onto the pool wall, and when necessary, a user can also detach the lighting apparatus from the pool wall.

### SUMMARY

The present disclosure provides a pool lighting apparatus, including: a main body having a first portion and a second portion; wherein the second portion connected to the first portion and having a second surface, wherein the second surface intersects a first surface of the first portion, and the second portion comprises a illumination assembly; a clamping assembly connected to the main body, wherein the clamping assembly connects to the first portion or the section portion, wherein the clamping assembly defines a clamping space or the clamping assembly cooperates with the second surface to define a clamping space; the clamping space is configured to receive a pool wall therein, wherein the clamping assembly and/or the second portion being movable along an adjustment direction to vary a size of the clamping space, the adjustment direction being parallel to the first surface

Furthermore, the clamping assembly includes a first clamping surface substantially parallel to the second surface, the clamping space is defined between the first clamping surface and the second surface.

Furthermore, the clamping assembly includes a first clamping plate configured to rotate relative to the first portion to switch between a deployed position and a folded position.

Furthermore, the clamping assembly further includes a first extension plate connected to the first clamping plate.

Furthermore, the first clamping plate includes a first plate body and two first side plates disposed on opposite sides of the first plate body; when the first clamping plate is in the folded position, the first extension plate is accommodated within the first clamping plate.

Furthermore, the first clamping plate is rotatably connected to the first extension plate, the first clamping plate includes a first clamping plate contact layer, the first extension plate includes a first extension plate contact layer, and the first clamping plate contact layer is offset from the first extension plate contact layer.

Furthermore, the clamping assembly includes a bracket and a first clamping plate, the bracket is connected to the first portion, and the first clamping plate is connected to the bracket.

Furthermore, the clamping assembly is configured to move along the adjustment direction; the bracket includes a fixed component connected to the first portion and a sliding component slidably engaged with the fixed component along the adjustment direction; and the first clamping plate is connected to the sliding component.

Furthermore, the clamping assembly further includes a limiting component including: a first limiting portion disposed on the fixed component or on the first portion; and a second limiting portion disposed on the sliding component; wherein the first limiting portion cooperates with the second limiting portion to prevent sliding movement of the sliding component in at least one direction.

Furthermore, the first limiting portion includes a row of first teeth, the second limiting portion includes a row of second teeth arranged along the adjustment direction, and the first teeth are engaged with the second teeth to prevent sliding movement of the sliding component in the at least one direction.

Furthermore, the first limiting portion further includes: a lever configured to rotate relative to the first portion, and the first teeth are connected to the lever; an elastic element connected to the lever or the first teeth, and the elastic element is configured to apply a force toward the second teeth; a button connected to the lever, and the button is configured to disengage an engagement between the first teeth and the second teeth after being pressed.

Furthermore, the first limiting portion further includes a seat body connected to the fixing component or the first portion, the lever is rotatably connected to the seat body, and the button is slidably connected to the seat body.

Furthermore, the button is provided with a first guide post, the lever is provided with a first guide groove, the first guide groove extends along the adjustment direction, and the first guide post is located in the first guide groove.

Furthermore, the first limiting portion further includes a connecting block, the connecting block is connected to the first teeth, and the connecting block is slidably connected to the seat body, one end of the elastic element is in contact with the seat body, and the other end of the elastic element is in contact with the connecting block, and the lever is connected to the connecting block.

Furthermore, each of the first teeth includes a first inclined surface and a first blocking surface, each of the second teeth includes a second inclined surface and a second blocking surface; each of the first teeth is located between two of the second teeth; the first inclined surface is in contact with the second inclined surface of one of the second teeth, and the first blocking surface is in contact with the second blocking surface of another one of the second teeth.

Furthermore, the first inclined surface and the second inclined surface have the same inclination direction, and along an extension direction (X) of the bracket, the first inclined surface gradually moves away from the sliding component.

Furthermore, the clamping assembly further includes a tension spring, one end of the tension spring is connected to the sliding component, and the other end of the tension spring is connected to the fixing component.

Furthermore, the clamping assembly further includes a second clamping plate, the second clamping plate is connected to the bracket and is located between the first clamping plate and the second surface.

The present disclosure further provides a pool lighting apparatus, including: a main body having a first portion and a second portion, wherein the second surface intersects the first surface, the second portion includes a illumination assembly; the pool lighting apparatus further includes a clamping assembly, the clamping assembly is movably connected to the first portion, wherein the clamping assembly forms a clamping space, or the clamping assembly and the second surface together form a clamping space; wherein the clamping assembly includes a first clamping plate, and the first clamping plate is configured to rotate relative to the first portion to switch between a deployed position and a folded position.

Furthermore, the clamping assembly further includes a bracket and a second clamping plate, the bracket is connected to the first portion, both the first clamping plate and the second clamping plate are rotatably connected to the bracket, and the second clamping plate is located between the first clamping plate and the second surface.

Furthermore, also including a mounting plate parallel to the first surface, wherein the mounting plate is detachably mounted to a bottom of a first housing, and a side of the mounting plate facing away from the first housing is provided with a mounting layer.

The pool lighting apparatus according to embodiments of the present disclosure enables adjustment of the size of a clamping space by adjusting the position of a first clamping plate, thereby facilitating adaptation to swimming pools having different wall thicknesses. By providing both the first clamping plate and a second clamping plate, the first clamping plate is selected when the pool wall is thick, while the second clamping plate is selected when the pool wall is thin, resulting in a wide adjustment range. Both the first clamping plate and the second clamping plate have a folded position and a deployed position, thereby facilitating storage. By additionally providing a first extension plate on the basis of the first clamping plate, the contact area is increased. By pressing a button, automatic retraction of a sliding component can be achieved, rendering the operation simple and convenient.

### BRIEF DESCRIPTION OF THE DRAWINGS

In order to more clearly illustrate the technical solutions of the embodiments of the present disclosure, a brief introduction will be given below to the drawings required for use in the description of the embodiments. It is apparent that the drawings described below are merely some embodiments of the present disclosure. For those of ordinary skill in the art, other drawings may also be obtained based on these drawings without any creative effort.

FIG. 1 is a perspective structural view of a pool lighting apparatus according to one embodiment of the present disclosure.

FIG. 2 is a perspective structural view of the pool lighting apparatus according to one embodiment of the present disclosure, wherein a first clamping plate is in a deployed position.

FIG. 3 is a schematic view illustrating cooperation between the pool lighting apparatus according to one embodiment of the present disclosure and a swimming pool.

FIG. 4 is an exploded view of the pool lighting apparatus according to one embodiment of the present disclosure.

FIG. 5 is a perspective structural view of the pool lighting apparatus according to one embodiment of the present disclosure, wherein the first clamping plate and a first extension plate are in the deployed position.

FIG. 6 is a perspective structural view of a clamping assembly of the pool lighting apparatus according to one embodiment of the present disclosure.

FIG. 7 is a perspective structural view of a portion of the pool lighting apparatus according to one embodiment of the present disclosure.

FIG. 8 is a perspective structural view of the pool lighting apparatus according to one embodiment of the present disclosure, wherein the sliding component is in an extended state.

FIG. 9 is a perspective structural view of the clamping assembly according to one embodiment of the present disclosure in another state.

FIG. 10 is a side view of the pool lighting apparatus according to one embodiment of the present disclosure in another state.

FIG. 11 is an enlarged schematic view of portion A in FIG. 6.

FIG. 12 is a schematic view illustrating engagement between first teeth and second teeth according to one embodiment of the present disclosure.

FIG. 13 is a schematic view illustrating disengagement between the first teeth and the second teeth according to one embodiment of the present disclosure.

FIG. 14 is a perspective structural view of the pool lighting apparatus according to one embodiment of the present disclosure in another state.

FIG. 15 is an enlarged schematic view of portion B in FIG. 14.

FIG. 16 is an enlarged schematic view of portion C in FIG. 14.

FIG. 17 is a perspective structural view of a pool lighting apparatus according to another embodiment of the present disclosure.

FIG. 18 is an exploded view of the pool lighting apparatus according to another embodiment of the present disclosure.

FIG. 19 is a perspective structural view of a mounting plate according to another embodiment of the present disclosure.

FIG. 20 a perspective structural view of of a first portion and the second portion of the pool lighting apparatus according to another embodiment of the present disclosure.

### DESCRIPTION OF THE REFERENCE NUMERAL

100 pool lighting apparatus, 1000 main body, 10 first portion, 11 first housing, 111 first surface, 12 guide rail, 121 positioning protrusion, 13 recess, 14 light-sensing lamp. 20 second portion, 21 illumination assembly, 22 second housing, 23 flexible pad, 231 second surface, 30 battery, 40 charging assembly, 50 solar assembly, 60 switch, 70 clamping assembly, 7a first clamping surface, 7b second clamping surface, 71 first clamping plate, 711 first plate body, 7111 first relief groove, 712 first side plate, 7121 limiting groove, 713 first clamping plate contact layer, 72 first extension plate, 721 first extension plate contact layer, 7211 second relief groove, 75 bracket, 751 fixing component, 7511 engaging block, 7512 limiting protrusion, 752 sliding component, 76 second clamping plate, 761 second plate body, 762 second side plate, 763 second clamping plate contact layer, 77 second extension plate, 771 second extension plate contact layer, 78 limiting component, 781 first limiting portion, 7811 first teeth, 7811a first inclined surface, 7811b first blocking surface, 7812 lever, 7812a first guide groove, 7812b second guide groove, 7813 elastic element, 7814 button, 7814a first guide post, 7815 seat body, 7817 connecting block, 7817a second guide post, 782 second limiting portion, 7821 second teeth, 7821a second inclined surface, 7821b second blocking surface, 79 tension spring, 80 mounting plate, 81 mounting layer, 811 third side plate, 812 fourth side plate, 813 slide groove, 814 positioning groove, 815 reinforcing rib, X extension direction, Y retraction direction, 200 swimming pool, 201 pool edge, 202 pool wall, 301 through hole, 302 fixing screw.

### DETAILED DESCRIPTION OF THE EMBODIMENTS

Hereinafter, the technical solutions according to the embodiments of the present disclosure will be clearly and completely described with reference to the accompanying drawings of the embodiments of the present disclosure. Obviously, the described embodiments are some, rather than all, of the embodiments of the present disclosure. All other embodiments obtained by a person of ordinary skill in the art based on the embodiments of the present disclosure without making any creative effort shall fall within the protection scope of the present disclosure.

It should be understood that, as used in the present specification and the appended claims, the terms “comprise” and “include” (or “comprising” and “including”) indicate the presence of the stated features, integers, steps, operations, elements, and/or components, but do not preclude the presence or addition of one or more other features, integers, steps, operations, elements, components, and/or groups thereof.

It should further be understood that the terms used in the present specification of the disclosure are for the purpose of describing particular embodiments only and are not intended to limit the present disclosure. As used in the present specification and the appended claims, unless the context clearly dictates otherwise, the singular forms “a”, “an”, and “the” are intended to include the plural forms as well.

It should still further be understood that the term “and/or” as used in the present specification of the disclosure and the appended claims refers to any and all possible combinations and all combinations of one or more of the associated listed items, and includes such combinations.

In the related art, a lighting apparatus is capable of being clamped onto a pool wall 202 so as to provide illumination for a swimming pool 200. Such lighting apparatuses are fixed to the pool wall 202 by means of a clamping manner, and when necessary, a user is also able to detach the apparatus from the pool wall 202. However, the current lighting apparatuses still have certain room for improvement. For example, they are unable to clamp onto pool walls 202 of different thicknesses, thereby resulting in an inability to adapt to different types of swimming pools 200. As another example, their excessively large size renders them inconvenient for storage, and so forth.

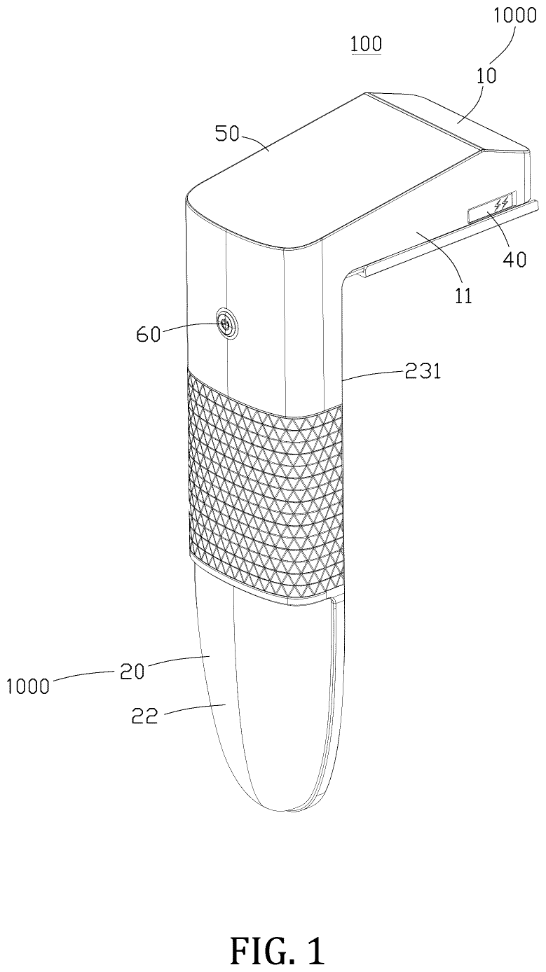

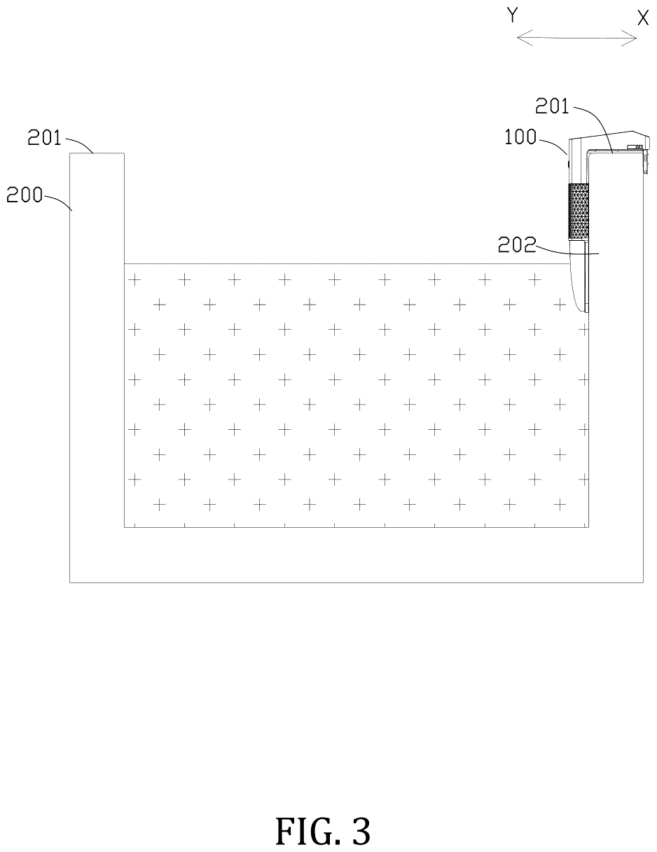

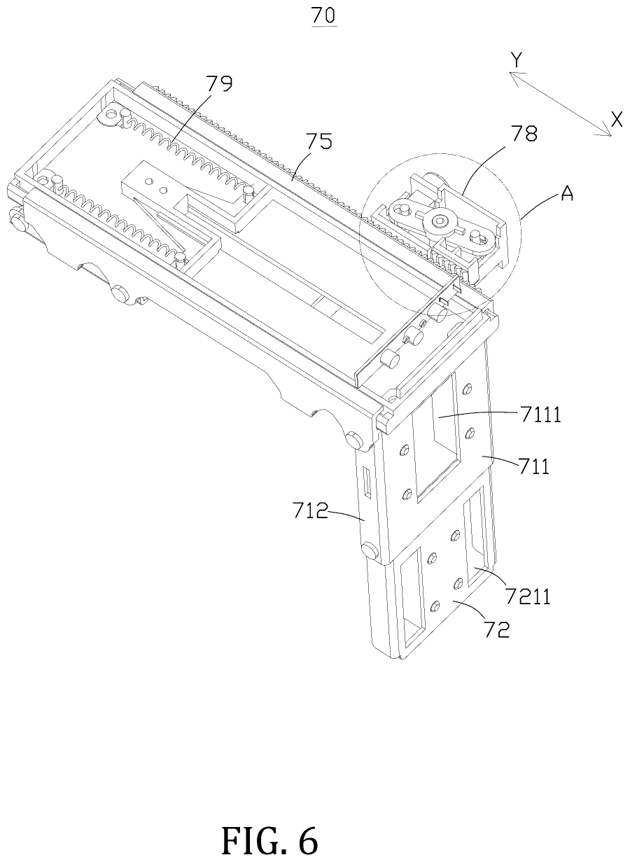

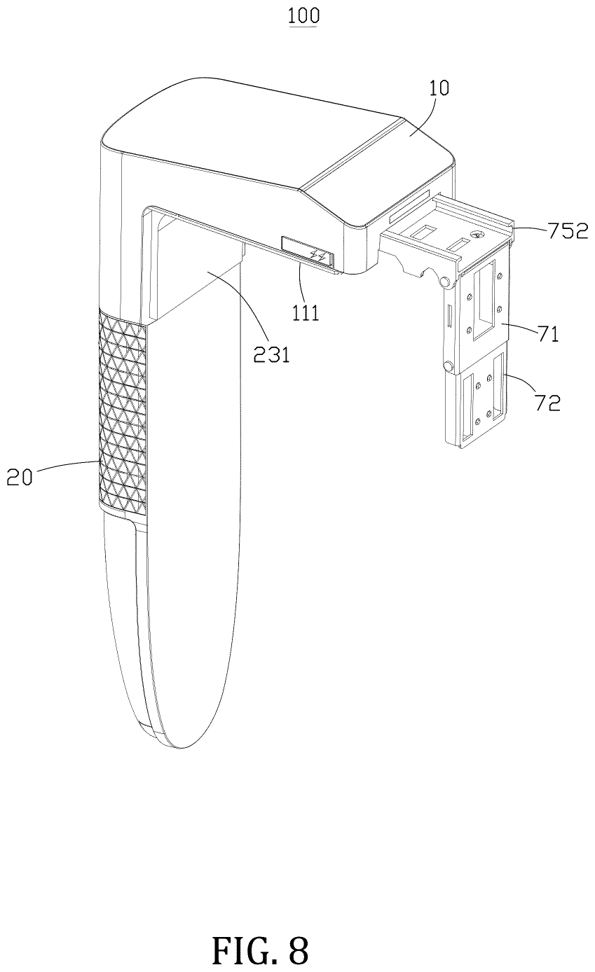

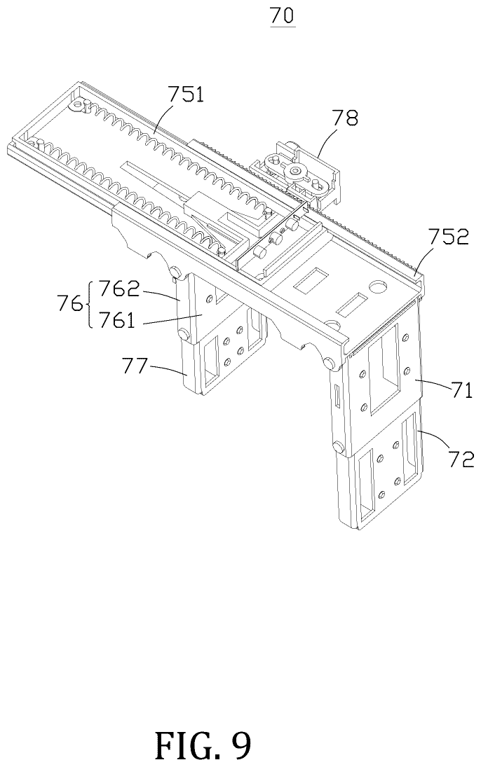

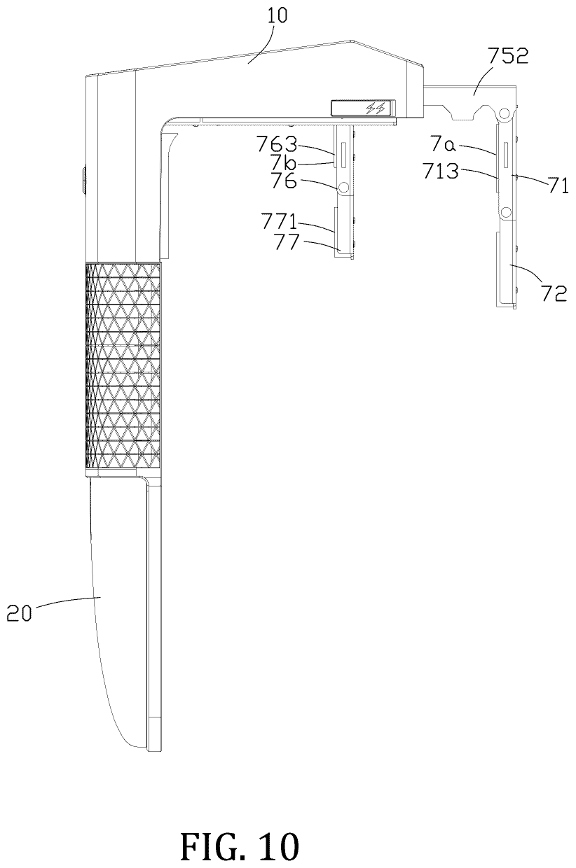

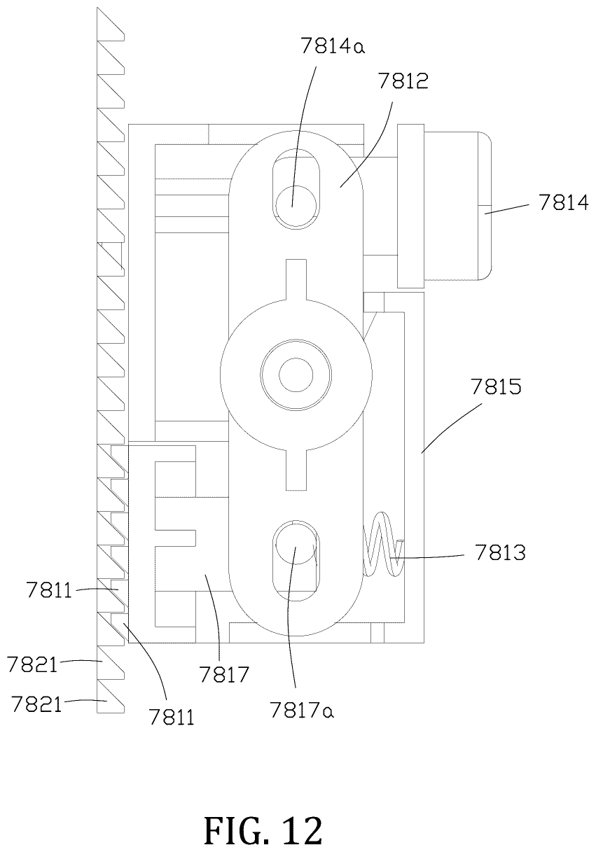

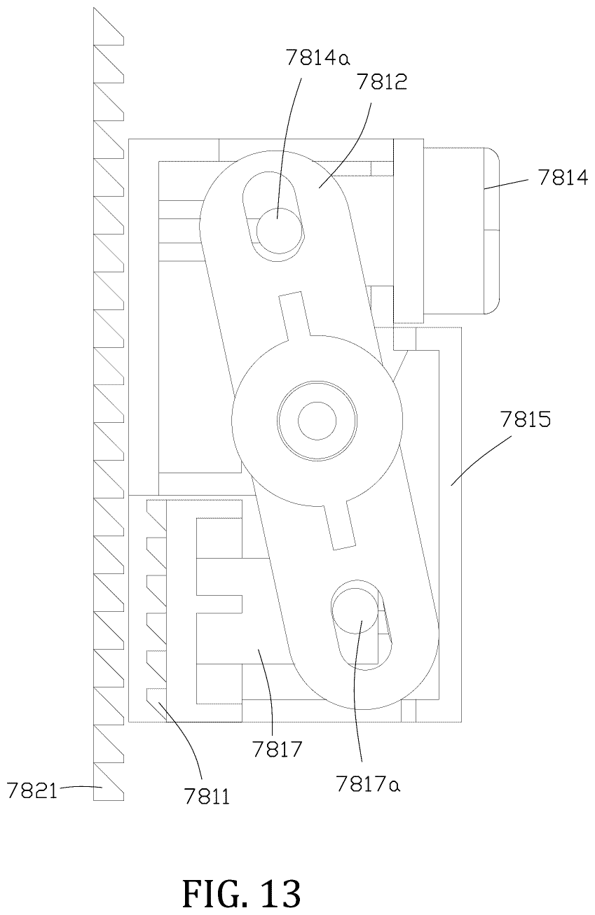

In order to address the above, embodiments of the present disclosure provide a pool lighting apparatus 100. Reference is made to FIG. 1 through FIG. 14. Specifically, reference may be made to FIG. 1 through FIG. 3, the pool lighting apparatus 100 includes a first portion 10 and a second portion 20. The first portion 10 has a first surface 111. The second portion 20 is connected to the first portion 10 and has a second surface 231. The second surface 231 intersects with the first surface 111.

The first portion 10 is generally disposed at a pool edge 201 of the swimming pool 200, while the second portion 20 is located within the swimming pool 200, and may be disposed either in the water or above the water surface of the swimming pool 200. In some embodiments, the first surface 111 is perpendicular to the second surface 231, and after installation on the swimming pool 200, the first surface 111 constitutes a horizontal plane, while the second surface 231 constitutes a vertical plane and is parallel to the pool wall 202. It should be understood that, in other embodiments, the first surface 111 and the second surface 231 may alternatively not be perpendicular to each other. For example, the first surface 111 and the second surface 231 may form an included angle therebetween, such as 80°, 100°, or the like, provided that the first portion 10 can be positioned at the pool edge 201 of the swimming pool 200 and the second portion 20 can be positioned within the swimming pool 200. The second portion 20 includes an illumination assembly 21, and the illumination assembly 21 is used for illuminating the swimming pool 200.

In some embodiments, the first portion 10 includes a first housing 11, a bottom surface of the first housing 11 constitutes the first surface 111, and a top surface of the first housing 11 includes of two inclined surfaces. It can be understood that, in other embodiments, the first housing 11 may alternatively be in the shape of a rectangular cuboid, a cylinder, or other shapes. The second portion 20 includes a second housing 22. The second housing 22 is connected to the first housing 11. The manner of connection is not limited and may be, for example, integral molding, snap-fit connection, bolted connection, or other connection methods. The second housing 22 is substantially arranged in a vertical orientation, such that the overall shape of the lighting apparatus assumes an inverted “L” configuration.

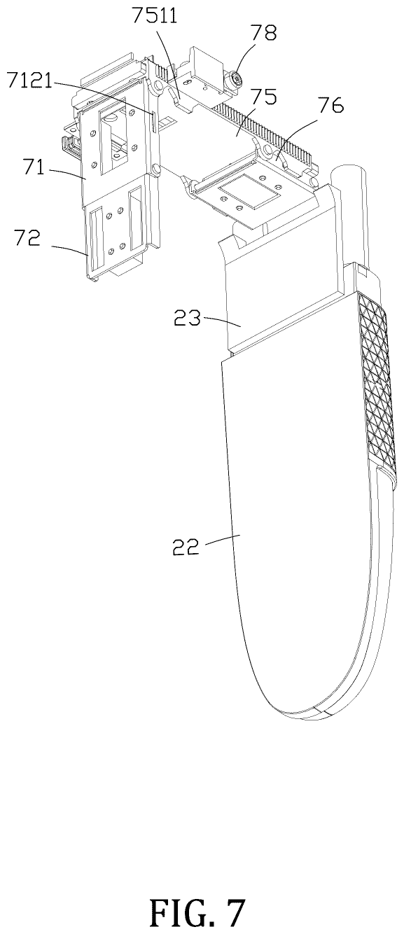

In some embodiments, a side of the second housing 22 proximate to the first housing 11 is provided with a flexible pad 23 (as shown in FIG. 7), and a side of the flexible pad 23 facing away from the second housing 22 constitutes the second surface 231. The flexible pad 23 is capable of coming into contact with a sidewall of the swimming pool 200. The flexible pad 23 may be a rubber pad or a pad made of another flexible material. It can be understood that, in other embodiments, the flexible pad 23 may alternatively be omitted. When the second housing 22 is not provided with the flexible pad 23 and thus the second housing 22 directly contacts the sidewall of the swimming pool 200, it can be understood that a sidewall of the second housing 22 itself constitutes the second surface 231.

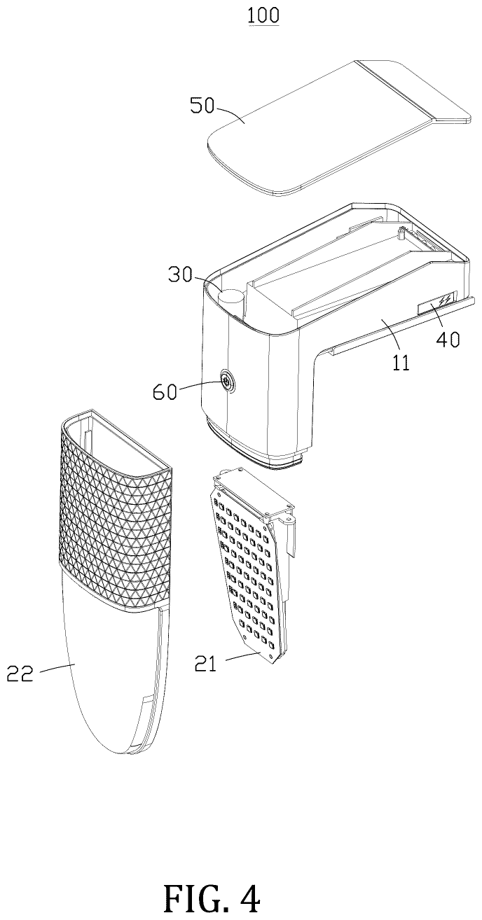

With reference to FIG. 4, in some embodiments, the pool lighting apparatus 100 further includes a battery 30, a charging assembly 40, and a solar assembly 50. The battery 30 is disposed inside at least one of the first housing 11 and the second housing 22. Both the charging assembly 40 and the solar assembly 50 are connected to the battery 30, and both the charging assembly 40 and the solar assembly 50 are mounted on the first housing 11 for charging the battery 30. The battery 30 is electrically connected to the illumination assembly 21 for supplying energy to the illumination.

In some embodiments, the pool lighting apparatus 100 further includes a switch 60. The switch 60 is disposed on the second housing 22 and is connected to the illumination assembly 21 for controlling the illumination assembly 21 to be turned on or turned off.

In some embodiments, an end of the first housing 11 away from the second housing is provided with a light-sensing lamp 14. The light-sensing lamp 14 is connected to the battery. The light-sensing lamp 14 is further connected to a light-sensing module. The light-sensing module is capable of controlling the turning on or turning off of the light-sensing lamp according to the intensity of ambient light.

In some embodiments, the light-sensing module is further electrically connected to the illumination assembly 21. The light-sensing module is capable of controlling the turning on or turning off of the illumination assembly 21 according to the intensity of ambient light.

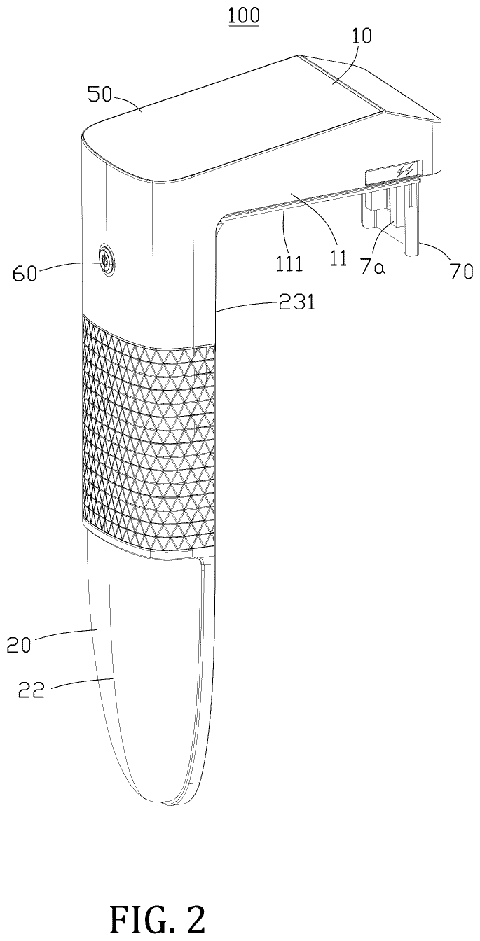

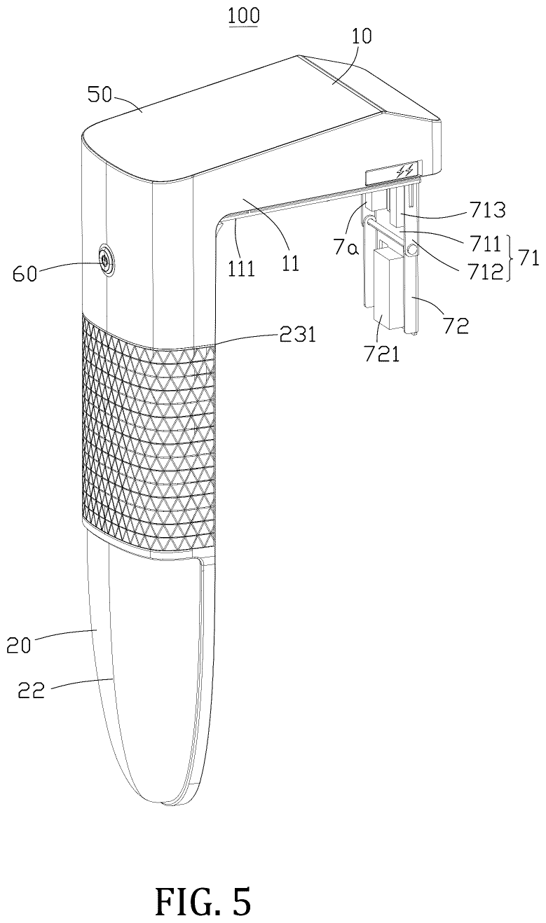

Reference is made to FIG. 2 and FIG. 5. In some embodiments, the pool lighting apparatus 100 further includes a clamping assembly 70. The clamping assembly 70 is connected to the first portion 10. The clamping assembly 70 forms a clamping space, or the clamping assembly 70 and the second surface 231 together form a clamping space. The pool wall 202 can be located within the clamping space, thereby enabling the pool lighting apparatus 100 to be fixed to the swimming pool 200. The clamping space may be formed solely by the clamping assembly 70. For example, the clamping assembly 70 may include two clamping plates, wherein one clamping plate corresponds in function to the second surface 231 and cooperates with the other clamping plate. In other embodiments, the clamping space may alternatively be formed jointly by the clamping assembly 70 and the second surface 231.

In some embodiments, at least one of the clamping assembly 70 and the second portion 20 is movable along an adjustment direction. That is, at least one of the clamping assembly 70 and the second portion 20 is movable relative to the first portion 10.

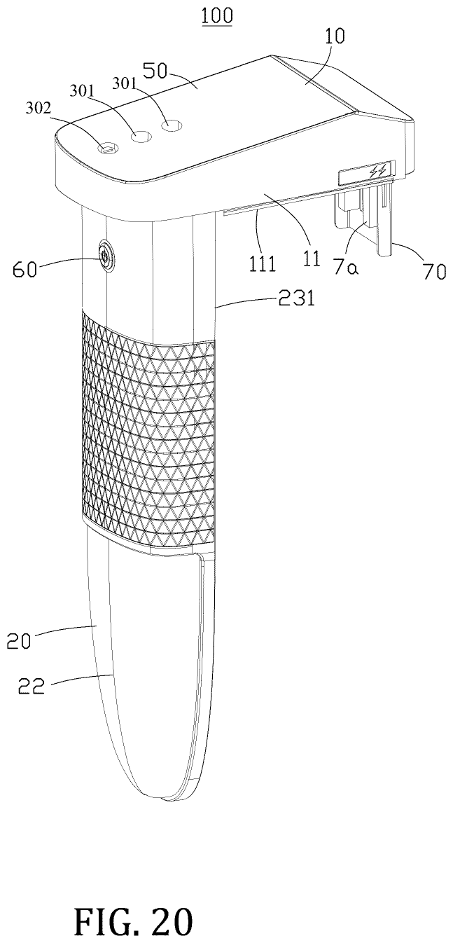

Refering to FIG. 20, in embodiments where the second portion 20 is movable relative to the first portion 10, the second housing 22 may be slidably connected to the first housing 11, for example. In particular, the first portion 10 is provided with a plurality of rows of penetrating though holes 301. The second portion 20 is detachably connected to the first portion 10 by means of a fixing screw 302. By screwing the fixing screw 302 into the through holes 301 at different positions, the relative position between the first portion 10 and the second portion 20 can be adjusted. Consequently, the dimension of the clamping space can be flexibly and adaptively changed to accommodate workpieces or objects of varying sizes.

Embodiments in which the clamping assembly 70 is movable relative to the first portion 10 will be described in detail later. By controlling the sliding movement of the clamping assembly 70 or the second portion 20, the size of the clamping space is adjusted so as to accommodate pool walls 202 of different thicknesses. The adjustment direction is parallel to the first surface 111. Optionally, the adjustment direction may be perpendicular to the second surface 231. The adjustment direction includes an extension direction X and a retraction direction Y. Movement in the extension direction X enables clamping of thicker pool walls 202, whereas movement in the retraction direction Y enables clamping of thinner pool walls 202.

In some embodiments, the clamping assembly 70 includes a first clamping surface 7a. The first clamping surface 7a is parallel to the second surface 231. A clamping space is formed between the first clamping surface 7a and the second surface 231. That is, the first clamping surface 7a can come into contact with the outer side of the pool wall 202, while the second surface 231 comes into contact with the inner side of the pool wall 202. Typically, the outer side and the inner side of the pool wall 202 are parallel to each other. By arranging the first clamping surface 7a parallel to the second surface 231, the contact area between the first clamping surface 7a and the second surface 231 with the pool wall 202 is increased.

With reference to FIG. 5 to FIG. 10, in some embodiments, the clamping assembly 70 includes a first clamping plate 71, wherein the first clamping surface 7a is disposed on the first clamping plate 71. The first clamping plate 71 is rotatable relative to the first portion 10 so as to be switchable between a deployed position and a folded position. When in the deployed position, the first clamping surface 7a is arranged substantially vertically and is capable of cooperating with the second surface 231. When in the folded position, the first clamping surface 7a is arranged substantially parallel to the first surface 111, thereby facilitating a reduction in overall volume and enabling convenient storage. In some embodiments, the first clamping plate 71 is movable relative to the first portion 10, thereby allowing adjustment of the clamping space. In other embodiments, the first clamping plate 71 may remain fixed relative to the first portion 10 at all times, that is, the dimension of the clamping space is fixed. For ease of understanding, the following description will take, as an illustrative example, the case where the first clamping plate 71 is capable of sliding relative to the first portion 10; the specific sliding manner of the first clamping plate 71 will be described in detail later.

In some embodiments, the clamping assembly 70 further includes a first extension plate 72, wherein the first extension plate 72 is rotatably or slidably connected to the first clamping plate 71. The first extension plate 72 likewise has a folded position and a deployed position. When the first extension plate 72 is moved into the folded position by sliding or rotation, the overall volume is advantageously reduced; when moved into the deployed position, the contact area is advantageously increased.

In some embodiments, the first clamping plate 71 includes a first plate body 711 and two first side plates 712, wherein one first side plate 712 is disposed on one side of the first plate body 711 and the other first side plate 712 is disposed on the opposite side of the first plate body 711. Such that the first clamping plate 71 is generally formed in a “U” shape, thereby providing sufficient internal space. When the first clamping plate 71 is in the folded position, the first extension plate 72 in its folded position can be accommodated inside the first clamping plate 71. The first extension plate 72 is rotatably connected to the first side plates 712.

In some embodiments, when both the first clamping plate 71 and the first extension plate 72 are in their respective folded positions, in a projection direction perpendicular to the first surface 111, the first extension plate 72 lies within the contour of the first clamping plate 71.

In some embodiments, the structure of the first extension plate 72 is similar to that of the first clamping plate 71 and is likewise generally formed in a “U” shape.

In some embodiments, the first clamping plate 71 is rotatably connected to the first extension plate 72 so as to enable unfolding or folding thereof. The first clamping plate 71 is provided with a first clamping plate contact layer 713, and the first extension plate 72 is provided with a first extension plate contact layer 721. The first clamping plate contact layer 713 and the first extension plate contact layer 721 are arranged in a staggered manner. When both the first clamping plate 71 and the first extension plate 72 are in their folded positions, in the projection direction perpendicular to the first surface 111, there is no overlapping portion between the first clamping plate contact layer 713 and the first extension plate contact layer 721.

In embodiments provided with the first clamping plate contact layer 713 and the first extension plate contact layer 721, the first clamping surface 7a is constituted by the surface of the first clamping plate contact layer 713 and the surface of the first extension plate contact layer 721 that face away from the corresponding first clamping plate 71 and first extension plate 72, respectively. The material of the contact layers may be rubber, silicone, or any other material capable of improving clamping stability.

In some embodiments, the thickness of the first clamping plate contact layer 713 and the thickness of the first extension plate contact layer 721 are greater than the height of the first side plates 712, such that the first clamping plate contact layer 713 and the first extension plate contact layer 721 can directly contact the pool wall 202. The first clamping plate 71 is provided with a first relief groove 7111, and the first extension plate 72 is provided with a second relief groove 7211. When the first extension plate 72 is folded into the first clamping plate 71, the first clamping plate contact layer 713 is received in the second relief groove 7211, and the first extension plate contact layer 721 is received in the first relief groove 7111.

In some embodiments, two ends of the first extension plate 72 are rotatably connected to the first clamping plate 71 via rotating shafts. The two first side plates 712 located on opposite sides of the first plate body 711 are each provided. Along their length direction, with a sliding slot configured to allow the rotating shaft to slide therein. The first extension plate 72 is slidable so as to be received inside the first clamping plate 71 or extended outside the first clamping plate 71, thereby achieving storage and deployment of the first extension plate 72 relative to the first clamping plate 71.

In some embodiments, the clamping assembly 70 further includes a bracket 75, wherein the bracket 75 is connected to the first portion 10. Specifically, the bracket 75 is connected to the first housing 11 of the first portion 10. The first housing 11 may be provided with a recess 13 at the bottom, that is, at the position of the first surface 111, and the bracket 75 is mounted in the recess 13. In other embodiments, the bracket 75 may alternatively be connected to the second housing 22 of the second portion 20, or may be located below the first housing 11. In some embodiments, the first clamping plate 71 may be rotatably connected to the bracket 75. In other embodiments, the first clamping plate 71 may be fixedly connected to the bracket 75. The following description of the present disclosure will take, as an illustrative example, the case where the first clamping plate 71 is rotatably connected to the bracket 75.

The first side plate 712 is provided with a limiting groove 7121, and the bracket 75 is provided with a limiting protrusion 7512. When the first clamping plate 71 is in the folded state, the limiting protrusion 7512 is located in the limiting groove 7121, thereby enhancing positional stability of the first clamping plate 71 and preventing the first clamping plate 71 from shaking or rotating while in the folded state.

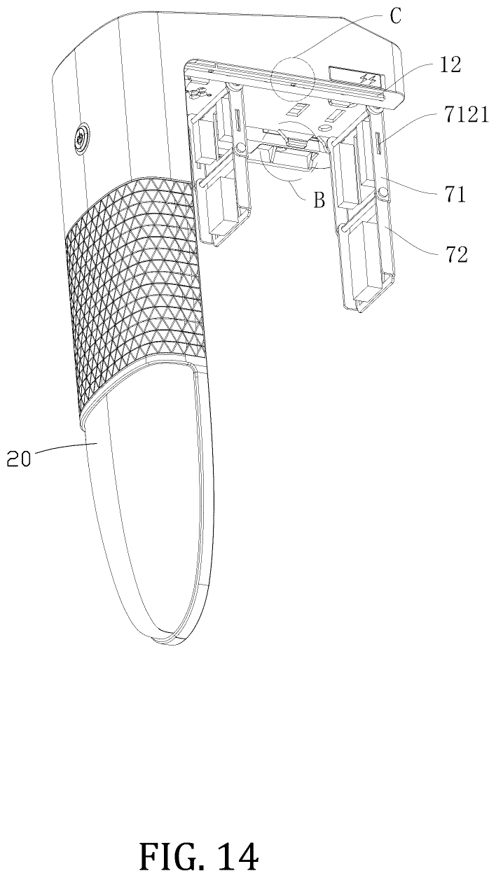

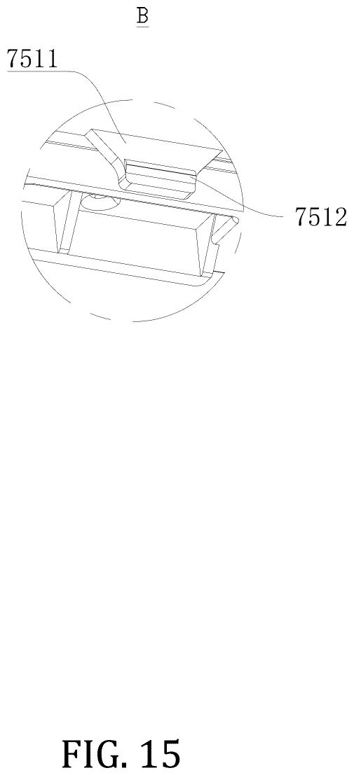

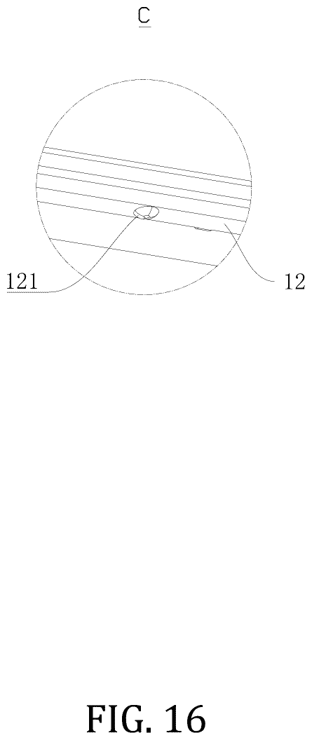

With reference to FIG. 14, FIG. 15, and FIG. 16, the limiting groove 7121 is formed as an elongated structure and is arranged along the length direction of the first side plate 712. At least one engaging block 7511 is provided on each of two side edges of the bracket 75, and an inner wall of the engaging block 7511 is provided with the limiting protrusion 7512 that matches the limiting groove 7121. In the present embodiment, engaging blocks 7511 are provided on both side edges of the bracket 75, and the limiting protrusion 7512 is an elongated structure having an arc-shaped cross-section. When the first clamping plate 71 is in the folded position, the limiting protrusion 7512 snaps into the limiting groove 7121, thereby achieving a certain degree of relative fixation between the first clamping plate 71 and the bracket 75 and preventing the first clamping plate 71 from shaking or swinging relative to the bracket 75 after being folded. In some embodiments, the limiting groove 7121 may alternatively be a circular groove, the limiting protrusion 7512 may be a circular protrusion, and the limiting groove 7121 may be a blind hole or a through hole; no limitation is imposed thereto.

In some embodiments, the clamping assembly 70 further includes a second clamping plate 76. The second clamping plate 76 is connected to the bracket 75 and is located between the first clamping plate 71 and the second surface 231, thereby forming different clamping spaces. A side of the second clamping plate 76 facing toward the second surface 231 constitutes a second clamping surface 7b. When clamping a relatively thin pool wall 202, the second clamping surface 7b of the second clamping plate 76 may be selected to cooperate with the second surface 231 for clamping. When clamping a relatively thick pool wall 202, the first clamping surface 7a of the first clamping plate 71 may be selected to cooperate with the second surface 231 for clamping.

In some embodiments, the second clamping plate 76 is rotatably connected to the bracket 75, thereby enabling the second clamping plate 76 to be deployed or folded. Optionally, the region between the second clamping plate 76 and the first clamping plate 71 may also be understood as a clamping space, wherein the second clamping plate 76 and the first clamping plate 71 cooperate to clamp the pool wall 202. When the second clamping plate 76 is in the deployed state, it is capable of being fixed relative to the bracket 75, thereby enhancing clamping stability. The fixing manner is not particularly limited; for example, the fixation may be achieved through a spring latch and slot engagement structure, or through bolt fastening, or by other suitable fixing means known in the art.

In some embodiments, the clamping assembly 70 further includes a second extension plate 77, wherein the second extension plate 77 is rotatably or slidably connected to the second clamping plate 76. The second extension plate 77 likewise has a folded position and a deployed position.

In some embodiments, the second clamping plate 76 includes a second plate body 761 and two second side plates 762. One of the second side plates 762 is disposed on one side of the second plate body 761, and the other second side plate 762 is disposed on the opposite side of the second plate body 761, such that the second clamping plate 76 is generally formed in a “U” shape. This configuration provides sufficient accommodation space, allowing the second extension plate 77, when in the folded position, to be received within the interior of the second clamping plate 76 when the second clamping plate 76 itself is also in the folded position. The second extension plate 77 is rotatably connected to the second side plates 762.

In some embodiments, when both the second clamping plate 76 and the second extension plate 77 are in their respective folded positions, the projection of the second extension plate 77 along the direction perpendicular to the second surface 231 falls entirely within the projection of the second clamping plate 76.

In some embodiments, the structure of the second extension plate 77 is similar to that of the second clamping plate 76 and is likewise generally formed in a “U” shape.

In some embodiments, the second clamping plate 76 is provided with a second clamping plate contact layer 763, and the second extension plate 77 is provided with a second extension plate contact layer 771. The second clamping plate contact layer 763 and the second extension plate contact layer 771 are arranged in a staggered manner; that is, when both the second clamping plate 76 and the second extension plate 77 are in their folded positions, there is no overlapping portion between the projection of the second clamping plate contact layer 763 and the projection of the second extension plate contact layer 771 along the direction perpendicular to the second surface 231.

In embodiments provided with the second clamping plate contact layer 763 and the second extension plate contact layer 771, the second clamping surface 7b is defined as the surface of the second clamping plate contact layer 763 and the second extension plate contact layer 771 that faces away from the corresponding second clamping plate 76 and second extension plate 77, respectively.

In some embodiments, the clamping assembly 70 is movable along an adjustment direction. The bracket 75 includes a fixed component 751 and a sliding component 752. The fixed component 751 is connected to the first housing 11 of the first portion 10. The sliding component 752 is slidably connected to the fixed component 751 along the adjustment direction. Both the first clamping plate 71 and the second clamping plate 76 are connected to the sliding component 752. Sliding movement of the sliding component 752 drives corresponding sliding movement of the first clamping plate 71 and the second clamping plate 76.

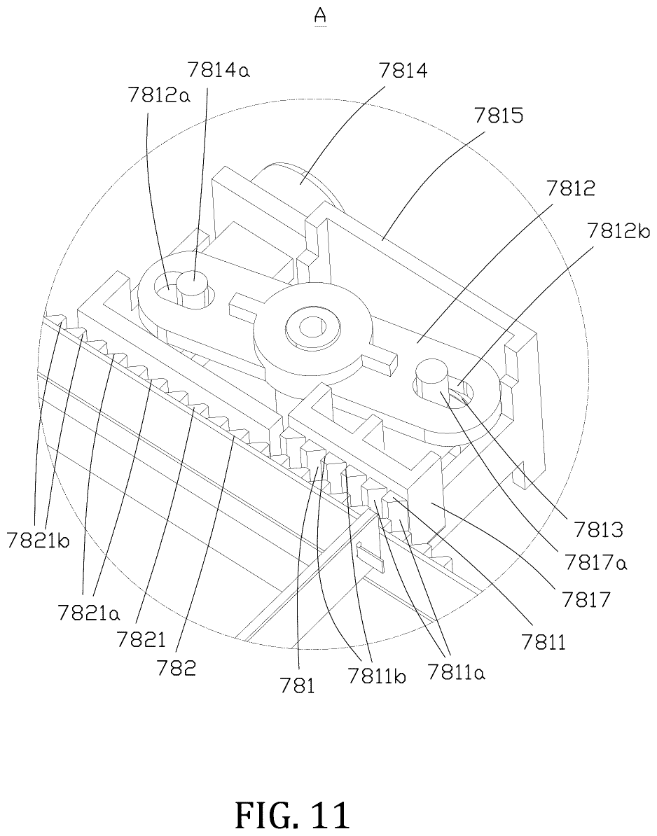

Referring to FIGS. 11 to 13, in some embodiments, the clamping assembly 70 further includes a limiting component 78. The limiting component 78 includes a first limiting portion 781 and a second limiting portion 782. The first limiting portion 781 is provided on the fixed component 751 or on the first portion 10. The second limiting portion 782 is provided on the sliding component 752. The first limiting portion 781 cooperates with the second limiting portion 782 so as to prevent sliding of the sliding component 752 in at least one direction.

When the first limiting portion 781 engages with the second limiting portion 782, sliding of the sliding component 752 is blocked, thereby maintaining stability of the clamping space and facilitating reliable clamping of the pool wall 202. When the first limiting portion 781 cooperates with the second limiting portion 782, sliding of the sliding component 752 in the extension direction X is prevented while sliding in the retraction direction Y remains allowed. In other embodiments, cooperation between the first limiting portion 781 and the second limiting portion 782 prevents sliding in the retraction direction Y while permitting sliding in the extension direction X. In still further embodiments, cooperation between the first limiting portion 781 and the second limiting portion 782 prevents sliding of the sliding component 752 in both the extension direction X and the retraction direction Y.

In some embodiments, the first limiting portion 781 includes a row of first teeth 7811, and the second limiting portion 782 includes a row of second teeth 7821 arranged along the adjustment direction. The first teeth 7811 engages with the second teeth 7821 so as to prevent sliding of the sliding component 752 in at least one direction. The number of first teeth 7811 is not particularly limited and may be one or more. The number of second teeth 7821 is typically plural so as to enable engagement between the first teeth 7811 and the second teeth 7821 at different positions of the sliding component 752. It should be noted that, in alternative embodiments, the first limiting portion 781 may include a row of first teeth 7811 arranged along the adjustment direction, while the number of second teeth 7821 is not particularly limited.

In some embodiments, the first limiting portion 781 further includes a lever 7812, an elastic component 7813, and a button 7814. The lever 7812 is rotatable relative to the first portion 10. The first teeth 7811 are connected to the lever 7812. The elastic component 7813 is connected to the lever 7812 or to the first teeth 7811 and applies a force urging the first teeth 7811 toward the second teeth 7821. The button 7814 is connected to the lever 7812 such that pressing the button 7814 disengages the first teeth 7811 from the second teeth 7821. Specifically, the button 7814 is located at one end of the lever 7812, while the first teeth 7811 are located at the other end of the lever 7812. Pressing the button 7814 causes rotation of the lever 7812, thereby moving the first teeth 7811 away from the second teeth 7821 and releasing the engagement. When the button 7814 is not pressed, the elastic force of the elastic component 7813 urges the first teeth 7811 toward the second teeth 7821 to maintain engagement, and also urges the lever 7812 to rotate so as to return the button 7814 to its initial position.

In some embodiments, the first limiting portion 781 further includes a seat body 7815. The seat body 7815 is connected to the fixed component 751 or to the first portion 10. The lever 7812 is rotatably connected to the seat body 7815, and the button 7814 is slidably connected to the seat body 7815. The seat body 7815 may be connected to the first housing 11. It will be appreciated that, in other embodiments, the seat body 7815 may alternatively be connected to the fixed component 751, or the seat body 7815 may be omitted, with the lever 7812, elastic component 7813, and button 7814 are directly mounted on the first housing 11 of the first portion 10.

In some embodiments, the button 7814 is provided with a first guide post 7814a, and the lever 7812 is provided with a first guide slot 7812a extending along the adjustment direction. The first guide post 7814a is positioned within the first guide slot 7812a. Through the cooperation between the first guide post 7814a and the first guide slot 7812a, sliding movement of the button 7814 causes corresponding rotation of the lever 7812.

In some embodiments, the first limiting portion 781 further includes a connecting block 7817. The connecting block 7817 is connected to the first teeth 7811 and is slidably connected to the seat body 7815. One end of the elastic component 7813 abuts against the seat body 7815, while the other end abuts against the connecting block 7817. The lever 7812 is connected to the connecting block 7817.

The connecting block 7817 is provided with a second guide post 7817a, and the lever 7812 is provided with a second guide slot 7812b extending along the adjustment direction. The second guide post 7817a is positioned within the second guide slot 7812b.

In some embodiments, each of the first teeth 7811 has a first inclined surface 7811a and a first blocking surface 7811b, and each second teeth 7821 has a second inclined surface 7821a and a second blocking surface 7821b. The first teeth 7811 are located between two adjacent second teeth 7821. The first inclined surface 7811a contacts the second inclined surface 7821a of one second teeth 7821, while the first blocking surface 7811b contacts the second blocking surface 7821b of the other second teeth 7821.

By bringing the first inclined surface 7811a into contact with the second inclined surface 7821a, and simultaneously bringing the first blocking surface 7811b into contact with the second blocking surface 7821b, when the first teeth 7811 are engaged with the second teeth 7821, the sliding component 752 remains capable of moving in the direction along the first inclined surface 7811a toward the second inclined surface 7821a in contact therewith, while being prevented from moving in the direction toward the second blocking surface 7821b in contact with the first blocking surface 7811b. In other words, sliding is permitted in one of the extension direction X and the retraction direction Y, while movement is restricted in the other direction.

It will be appreciated that, in other embodiments, both the first teeth 7811 and the second teeth 7821 may be provided with two blocking surfaces without any inclined surface, thereby achieving restriction in both directions. In such cases, the first blocking surface 7811b is parallel to the second blocking surface 7821b and perpendicular to the adjustment direction.

In some embodiments, the first inclined surface 7811a and the second inclined surface 7821a are inclined in the same direction. Toward the extension direction X of the bracket 75, the first inclined surface 7811a gradually approaches the sliding component 752. That is, when the first teeth 7811 are engaged with the second teeth 7821, no restriction is imposed on the sliding component 752 in the retraction direction Y.

In other embodiments, the first inclined surface 7811a and the second inclined surface 7821a are inclined in the same direction. Toward the extension direction X of the bracket 75, the first inclined surface 7811a gradually moves away from the sliding component 752. That is, when the first teeth 7811 are engaged with the second teeth 7821, no restriction is imposed on the sliding component 752 in the extension direction X. During extension of the bracket 75, there is no need to press the button 7814.

In some embodiments, the clamping assembly 70 further includes a tension spring 79. One end of the tension spring 79 is connected to the sliding component 752, and the other end is connected to the fixing component 751. When the bracket 75 is extended, the tension spring 79 is stretched, thereby applying a force to the sliding component 752 urging it toward retraction. Upon pressing the button 7814, the sliding component 752 automatically retracts.

In some embodiments, the first limiting portion 781 includes a plurality of holes arranged along the sliding direction of the sliding component 752 and provided on the first portion 10 or the fixing component 751. The second limiting portion 782 includes a rod capable of being inserted into any of the holes so as to define a relative position between the sliding component 752 and the fixing component 751.

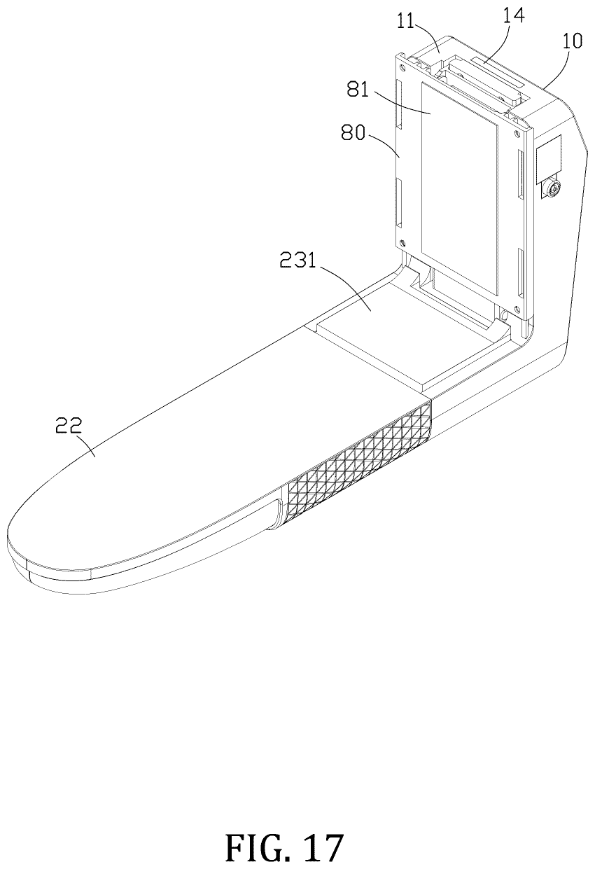

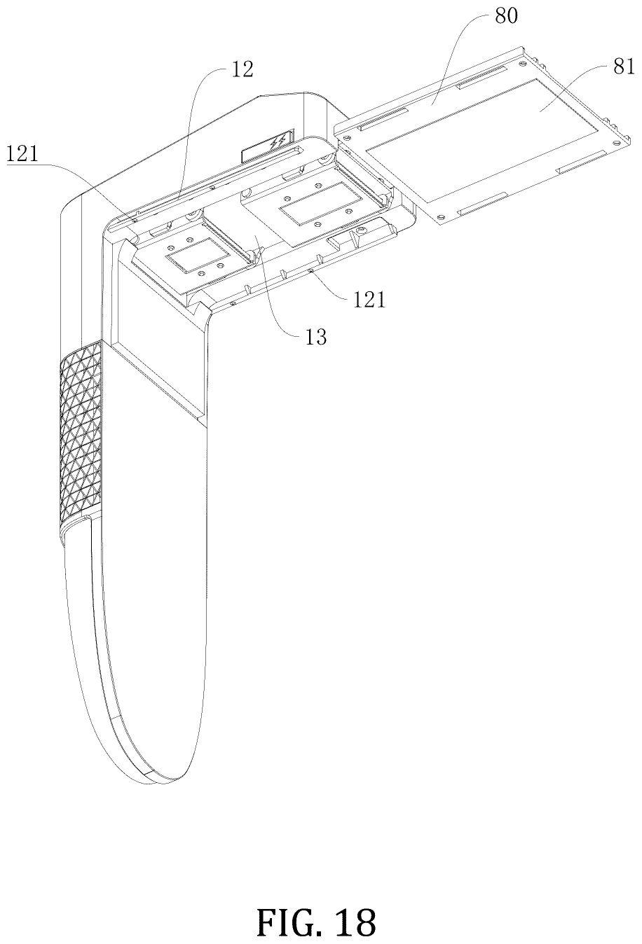

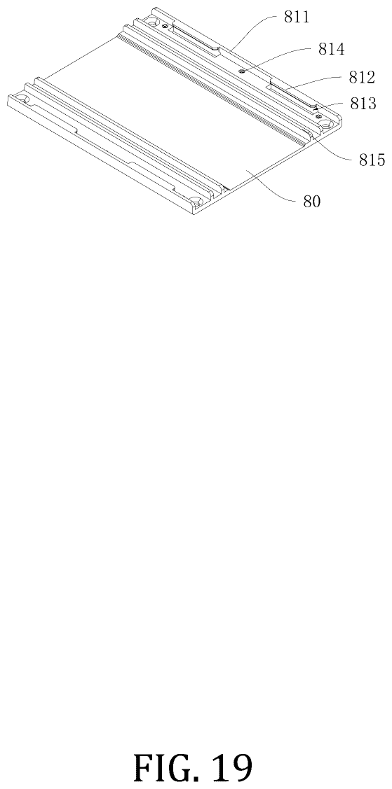

Referring to FIGS. 17, 18 and 19, in some embodiments, the pool lighting apparatus 100 further includes a mounting plate 80. The mounting plate 80 is parallel to the first face 111 and is mounted to the bottom of the first housing 11. Optionally, it may be mounted directly to the first face 111. When the pool lighting apparatus 100 is applied to a pool 200 having a relatively thick pool wall 202, the mounting plate 80 may be selected for installation on the pool 200.

A surface of the mounting plate 80 facing away from the first housing 11 is provided with a mounting layer 81 (i.e., the bottom surface of the mounting plate 80 may be provided with the mounting layer 81). In the present embodiment, the mounting layer 81 is an adhesive layer, facilitating connection of the pool lighting apparatus 100 to the pool 200 by means of adhesion. It will be appreciated that, in other embodiments, the mounting layer 81 is not limited to an adhesive and may alternatively be a hook-and-loop fastener, screws, or other structures, provided that the mounting plate 80 can be securely fastened to a pool having a relatively thick wall 202 by means of the mounting layer 81.

Optionally, the first housing 11 is slidably connected to the mounting plate 80 so as to allow separation of the first housing 11 from the mounting plate 80. In the present embodiment, one of the mounting plate 80 and the first housing 11 is provided with a sliding groove 813, while the other is provided with a guide rail 12 that mates therewith. Through engagement between the guide rail 12 and the sliding groove 813, the mounting plate 80 and the first housing 11 are detachably connected. In the present embodiment, two parallel guide rails 12 are provided, respectively located at positions on the bottom of the first housing 11 near the two side edges. The number of sliding grooves 813 corresponds to the number of guide rails 12 and is formed on the surface of the mounting plate 80 facing away from the adhesive 81. In the present embodiment, two sliding grooves 813 are provided in parallel at the two side edges of the mounting plate 80. Specifically, third side plates 811 are provided on both sides of the upper surface of the mounting plate 80 along the width direction, and fourth side plates 812 are provided at ends of the third side plates 811 remote from the mounting plate 80, such that an upwardly opening, substantially “U” shaped sliding groove 813 is formed between the upper surface of the mounting plate 80, the third side plate 811, and the fourth side plate 812. The sliding groove 813 is sleeved over the guide rail 12 and is capable of linear sliding along the adjustment direction, thereby facilitating convenient attachment and detachment of the mounting plate 80.

In some embodiments, the outer wall of the guide rail 12 is provided with a plurality of positioning protrusions 121 along its length direction, and the inner wall of the sliding groove 813 or the outer surface of the mounting plate 80 is provided with positioning recesses 814 adapted to mate with the positioning protrusions 121 along the length direction. When the guide rail 12 slides along the sliding groove 813, precise assembly and stable connection between the mounting plate 80 and the first housing 11 can be achieved by means of the engagement between the positioning protrusions 121 and the positioning recesses 814. Specifically, the positioning recesses 814 may be arc-shaped grooves, and the positioning protrusions 121 may be arc-shaped protrusions.

In some embodiments, the mounting plate 80 may alternatively be mounted to the bottom surface of the first housing 11 by means of screws or other connection methods. In some embodiments, the surface of the mounting plate 80 is provided with reinforcing ribs 815 along the length direction. By providing the mounting plate 80, the application range of the pool lighting apparatus 100 is further expanded, thereby enhancing its multifunctionality.

It will be appreciated that, when the first clamping plate 71 is in the folded position, the mounting plate 80 can still be mounted to the bottom of the first housing 11.

In summary, embodiments of the present disclosure provide a pool lighting apparatus 100 in which the size of the clamping space can be adjusted by adjusting the position of the first clamping plate 71, thereby making it suitable for pools 200 of different wall thicknesses. By providing both the first clamping plate 71 and the second clamping plate 76, the first clamping plate 71 can be selected when the pool wall 202 is thick, while the second clamping plate 76 can be selected when the pool wall 202 is thin, thereby achieving a wide adjustment range. Both the first clamping plate 71 and the second clamping plate 76 have a folded position and a deployed position, facilitating storage. By adding the first extension plate 72 on the basis of the first clamping plate 71, the contact area is increased. Automatic retraction of the sliding component 752 can be achieved by simply pressing the button 7814, resulting in simple and convenient operation.

The above descriptions are merely specific embodiments of the present disclosure. However, the protection scope of the present disclosure is not limited thereto. Any person skilled in the art, within the technical scope disclosed in the present disclosure, can readily conceive of various equivalent modifications or substitutions, and such modifications or substitutions shall fall within the protection scope of the present disclosure. Therefore, the protection scope of the present disclosure shall be determined by the scope of the appended claims.

What is claimed is:

1. A pool lighting apparatus, comprising:
a main body having a first portion and a second portion;
wherein the second portion connected to the first portion and having a second surface, wherein the second surface intersects a first surface of the first portion, and the second portion comprises a illumination assembly;
a clamping assembly connected to the main body, wherein the clamping assembly connects to the first portion or the section portion, the clamping assembly defines a clamping space or the clamping assembly cooperates with the second surface to define a clamping space; the clamping space is configured to receive a pool wall therein, wherein the clamping assembly and/or the second portion being movable along an adjustment direction to vary a size of the clamping space, the adjustment direction being parallel to the first surface.

2. The pool lighting apparatus of claim 1, wherein the clamping assembly comprises a first clamping surface substantially parallel to the second surface, the clamping space is defined between the first clamping surface and the second surface.

3. The pool lighting apparatus of claim 1, wherein the clamping assembly comprises a first clamping plate configured to rotate relative to the first portion to switch between a deployed position and a folded position.

4. The pool lighting apparatus of claim 3, wherein the clamping assembly further comprises a first extension plate connected to the first clamping plate.

5. The pool lighting apparatus of claim 4, wherein the first clamping plate comprises a first plate body and two first side plates disposed on opposite sides of the first plate body;
wherein, when the first clamping plate is in the folded position, the first extension plate is accommodated within the first clamping plate.

6. The pool lighting apparatus of claim 4, wherein the first clamping plate is rotatably connected to the first extension plate, the first clamping plate comprises a first clamping plate contact layer, the first extension plate comprises a first extension plate contact layer, and the first clamping plate contact layer is offset from the first extension plate contact layer.

7. The pool lighting apparatus of claim 1, wherein the clamping assembly comprises a bracket and a first clamping plate, the bracket is connected to the first portion, and the first clamping plate is connected to the bracket.

8. The pool lighting apparatus of claim 7, wherein the clamping assembly is configured to move along the adjustment direction;
the bracket comprises a fixed component connected to the first portion and a sliding component slidably engaged with the fixed component along the adjustment direction; and
the first clamping plate is connected to the sliding component.

9. The pool lighting apparatus of claim 8, wherein the clamping assembly further comprises a limiting component comprising:
a first limiting portion disposed on the fixed component or on the first portion; and
a second limiting portion disposed on the sliding component;
wherein the first limiting portion cooperates with the second limiting portion to prevent sliding movement of the sliding component in at least one direction.

10. The pool lighting apparatus of claim 9, wherein the first limiting portion comprises a row of first teeth, the second limiting portion comprises a row of second teeth arranged along the adjustment direction, and the first teeth are engaged with the second teeth to prevent sliding movement of the sliding component in the at least one direction.

11. The pool lighting apparatus of claim 10, wherein the first limiting portion further comprises:
a lever configured to rotate relative to the first portion, and the first teeth are connected to the lever;
an elastic element connected to the lever or the first teeth, and the elastic element is configured to apply a force toward the second teeth;
a button connected to the lever, and the button is configured to disengage an engagement between the first teeth and the second teeth after being pressed.

12. The pool lighting apparatus of claim 11, wherein the first limiting portion further comprises a seat body connected to the fixing component or the first portion, the lever is rotatably connected to the seat body, and the button is slidably connected to the seat body.

13. The pool lighting apparatus of claim 12, wherein the button is provided with a first guide post, the lever is provided with a first guide groove, the first guide groove extends along the adjustment direction, and the first guide post is located in the first guide groove.

14. The pool lighting apparatus of claim 12, wherein the first limiting portion further comprises a connecting block, the connecting block is connected to the first teeth, and the connecting block is slidably connected to the seat body, one end of the elastic element is in contact with the seat body, and the other end of the elastic element is in contact with the connecting block, and the lever is connected to the connecting block.

15. The pool lighting apparatus of claim 10, wherein each of the first teeth comprises a first inclined surface and a first blocking surface, each of the second teeth comprises a second inclined surface and a second blocking surface; each of the first teeth is located between two of the second teeth;
wherein, the first inclined surface is in contact with the second inclined surface of one of the second teeth, and the first blocking surface is in contact with the second blocking surface of another one of the second teeth.

16. The pool lighting apparatus of claim 15, wherein the first inclined surface and the second inclined surface have the same inclination direction, and along an extension direction (X) of the bracket, the first inclined surface gradually moves away from the sliding component.

17. The pool lighting apparatus of claim 8, wherein the clamping assembly further comprises a tension spring, one end of the tension spring is connected to the sliding component, and the other end of the tension spring is connected to the fixing component.

18. The pool lighting apparatus of claim 7, wherein the clamping assembly further comprises a second clamping plate, the second clamping plate is connected to the bracket and is located between the first clamping plate and the second surface.

19. A pool lighting apparatus, comprising:
a main body having a first portion and a second portion;
wherein the the second surface intersects the first surface, the second portion comprises a illumination assembly;
a clamping assembly is movably connected to the first portion, wherein the clamping assembly forms a clamping space, or the clamping assembly and the second surface together form a clamping space; wherein the clamping assembly comprises a first clamping plate, and the first clamping plate is configured to rotate relative to the first portion to switch between a deployed position and a folded position.

20. The pool lighting apparatus of claim 19, wherein the clamping assembly further comprises a bracket and a second clamping plate, the bracket is connected to the first portion, both the first clamping plate and the second clamping plate are rotatably connected to the bracket, and the second clamping plate is located between the first clamping plate and the second surface.

21. The pool lighting apparatus of claim 19, further comprising a mounting plate parallel to the first surface, wherein the mounting plate is detachably mounted to a bottom of a first housing, and a side of the mounting plate facing away from the first housing is provided with a mounting layer.
